(19) United States
(12) Patent Application Publication
(10) Pub. No.: US 2018/0046177 A1
(43) Pub. Date: Feb. 15, 2018

(54) Motion Sensing Flight Control System Based on Smart Terminal and Terminal Equipment

(71) Applicant: GUANGZHOU EHANG INTELLIGENT TECHNOLOGY CO., LTD., Guangzhou, Guangdong (CN)

(72) Inventor: Huazhi Hu, Guangzhou, Guangdong (CN)

(21) Appl. No.: 15/555,518

(22) PCT Filed: Apr. 20, 2015
(86) PCT No.: PCT/CN2015/076934

§ 371 Date: Sep. 4, 2017

(30) Foreign Application Priority Data
Mar. 3, 2015 (CN) 201510094904.X

(51) Int. Cl. G05D 1/00; B64C 39/02; G01C 23/00; G08C 17/02; B64D 43/02

(52) U.S. Cl. CPC G05D 1/0016; G08C 17/02; B64D 43/02; G01C 23/00; B64C 39/024; H04M 1/0202

(57) ABSTRACT

A motion sensing flight control system based on a smart terminal (13) and terminal equipment. The system includes an airborne flight control system (11), a communication relay device (12), and a smart terminal (13). The smart terminal (13) is configured to acquire attitude information about itself, generate a flight command according to the attitude information, and send the flight command to the airborne flight control system (11) through the communication relay equipment (12). The attitude information at least includes a yaw angle of the smart terminal (13), and the flight command at least carries the yaw angle for indicating that the airborne flight control system (11) controls an aircraft flying at the yaw angle. The airborne flight control system (11) is configured to control the flight of the aircraft according to the flight command A multi-rotor aircraft is convenient to operate and suitable for beyond visual range flight.

### FIELD

The subject matter herein generally relates to the field of aircraft control technology, and more particularly to a motion sensing flight control system based on a smart terminal and terminal equipment.

### BACKGROUND

A multi-rotor vehicle is a small aircraft that provides power through multiple (usually at least four) rotors. As the multi-rotor aircraft has vertical takeoff and hovering ability, flight is stable, and the cost is relatively low. The multi-rotor aircraft is widely used in personal entertainment, film and television aerial photography, land surveying, agriculture and forestry inspection, power line inspection, police monitoring and many industries.

At present, there are two main ways to control small aircraft: one way is to use the remote control. The operator can directly control throttle, attitude angle, and flight speed by the remote control of the aircraft. This method can be very precise control of the aircraft, but the technical level of the operator is very high, and not suitable for over the horizon flight. When the aircraft and the operator away from the distance due to observation is not easy to cause misjudgment. Another way is to provide a fully equipped self-propelled vehicle for the aircraft, which relies on GPS (Global Positioning System) positioning. The ground station sends command to aircraft to take off, landing, flight according to the specified route. The self-propelled vehicle for the aircraft is easy to be controlled, but cannot be in the indoor or not open environment flight, and cannot be real time control.

### SUMMARY

The invention aims to provide a motion sensing flight control system based on a smart terminal and terminal equipment, so that the multi-rotor aircraft is convenient to be controlled and suitable for over the horizon flight.

In order to achieve the aim, the technical scheme adopted by the invention is as follows:

A motion sensing flight control system based on a smart terminal includes: an airborne flight control system, a communication relay device, and a smart terminal;

The smart terminal is configured to acquire attitude information of the smart terminal, generate a flight command according to the attitude information, and send the flight command to the airborne flight control system through the communication relay device; wherein the attitude information includes at least a yaw angle of the smart terminal, and the flight command at least carries the yaw angle for indicating that the airborne flight control system controls an aircraft flying at the yaw angle;

The airborne flight control system is configured to control the flight of the aircraft in accordance with the flight command

A smart terminal for controlling the flight of an aircraft includes: an attitude sensor, a control module, and a second relay module, the attitude sensor and the second relay module are respectively connected to the control module;

The attitude sensor is configured to obtain an attitude information of the smart terminal, the attitude information at least includes a yaw angle of the aircraft;

The control module is configured to generate a flight command according to the attitude information and send the flight command to the second relay module, the flight command at least carries the yaw angle for indicating the aircraft flying at the yaw angle;

The second relay module is configured to send the flight command to the aircraft of an airborne flight control system through the communication relay device.

An airborne flight control system includes: a microprocessor and a first wireless data transmission module connected to the microprocessor;

The microprocessor is configured to receive a flight command of a smart terminal from a communication relay device through the first wireless data transmission module, and control the flight of an aircraft according to the flight command; wherein the flight command at least carries a yaw angle for indicating that the airborne flight control system controls the aircraft flying at the yaw angle, the yaw angle is a yaw angle of the smart terminal.

A communication relay device includes: a first relay module, and a second wireless data transmission module connected to the first relay module;

The first relay module is configured to communicate with a smart terminal, and receive a flight command sent by the smart terminal, wherein the flight command at least carries a yaw angle for indicating that a airborne flight control system controls the aircraft on which the airborne flight control system is located to fly at the yaw angle, and the yaw angle is the yaw angle of the smart terminal;

The second wireless data transmission module is configured to wireless communication with the airborne flight control system, and sends the flight command to the airborne flight control system.

The motion sensing flight control system based on a smart terminal and the terminal equipment provided by the invention, according to the perception of the posture of the smart terminal, the smart terminal generates flight command to indicate that the airborne flight control system controls the flight of the aircraft, and send the flight command to the airborne flight control system to control the flight of the aircraft, so that the aircraft can fly in accordance with the posture of the smart terminal automatically adjust the yaw angle, which achieves the motion sensing flight control based on smart terminal Since the smart terminal can control the aircraft through its own posture, and the click and the sliding control on the smart terminal, the technical level of the operator is effectively reduced, so that the flight control of the aircraft becomes easier. The user does not need to be trained, and accurate control on the unmanned aerial vehicle similar to the remote controller can be achieved through motion sensing control.

The use of smart phones to achieve this method, it does not need require to special motion sensing equipment. Moreover, the smart terminal communicates with the airborne flight control system on the aircraft through the communication relay equipment, which allows the aircraft to fly indoor and non-GPS signals or weak GPS signals while controlling the aircraft for over the horizon flight.

### BRIEF DESCRIPTION OF THE DRAWINGS

In order to more clearly illustrate the embodiments of the present invention or the technical solutions in the prior art, the following drawings, which are intended to be used in the description of the embodiments or the prior art are briefly described. It will be apparent that the drawings are some embodiments of the present invention, and other drawings may be obtained by those skilled in the art without departing from the inventive work.

FIG. 1 is a schematic diagram of a motion sensing flight control system based on a smart terminal according to an embodiment of the present invention;

FIG. 2 is a schematic diagram of a motion sensing flight control system based on a smart terminal according to a second embodiment of the present invention;

FIG. 3 is a schematic diagram of a smart terminal for controlling an aircraft flight according to a third embodiment of the present invention;

FIG. 4 is a schematic diagram of an airborne flight control system according to a fourth embodiment of the present invention;

FIG. 5 is a schematic diagram of a communication relay apparatus according to a fifth embodiment of the present invention;

FIG. 6a is a schematic diagram of a motion sensing flight control system based on a smart terminal according to a sixth embodiment of the present invention;

FIG. 6b is a schematic diagram of a motion sensing flight control method of a motion sensing flight control system based on a smart terminal according to a sixth embodiment of the present invention.

### DETAILED DESCRIPTION

In order to make the purpose, technical scheme and advantages of the present invention more clearly, the following figures will be referenced to the embodiments of the present invention. The present invention will now be described, by way of example with reference to the accompanying drawings in which part of the embodiments, and not all embodiments. All other embodiments obtained by those of ordinary skill in the art without making creative work are within the scope of the present invention, based on embodiments in the present invention.

The motion sensing flight control system based on a smart terminal provided by the embodiment of the invention can be applied to the control of a plurality of aircrafts, such as multi-rotor unmanned aerial vehicles. In this system, the smart terminal can be a motion sensing device such as a motion sensing manipulator, or a portable electronic device capable of communicating with a smart phone and a portable computer with data processing function and capability of perceived self-operation.

### Embodiment 1

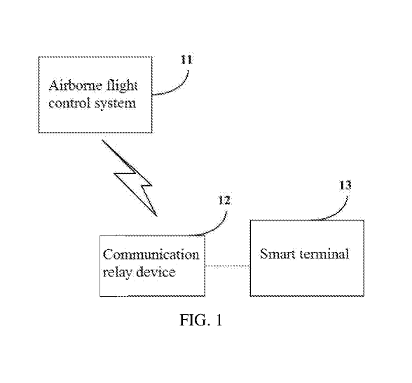

Referring to FIG. 1, a motion sensing flight control system based on a smart terminal according to an embodiment of the present invention, includes an airborne flight control system 11, a communication relay device 12, and a smart terminal 13.

The smart terminal 13 acquires an attitude information of the smart terminal 13, generates a flight command according to the attitude information, and sends the flight command to the airborne flight control system 11 through the communication relay device 12. The attitude information includes at least a yaw angle of the smart terminal 13. The flight command at least carries the yaw angle for indicating that the airborne flight control system 11 controls the aircraft flying at the yaw angle.

The airborne flight control system 11 controls the flight of the aircraft in accordance with the flight command

For example, when an aircraft is flying, the smart terminal 13 is rotated by 30 degrees rotating from the right hand system upward axis (Z axis) towards the negative direction of the X axis (the front axis of the right hand system) under the control of an operator or a user. The smart terminal 13 senses this operation and generates a flight command for which the target yaw angle is rotated by 30 degrees, and transmits it to the airborne flight control system 11 of the aircraft through the communication relay device 12. After receiving this command, the airborne flight control system 11 controls the aircraft to yaw 30 degrees in the negative direction of the X axis.

Alternatively, for example, the smart terminal 13 is rotated by 30 degrees in the negative direction of the Z axis to the X axis, rotated about 10 degrees in the positive direction of the X axis to the Z axis, and rotated about 20 degrees in the right hand axis (Y axis) to the negative direction of the X axis at the same time. The smart terminal 13 senses that it rotates in the positive direction of the Z axis to produce a roll angle of 10 degrees while sensing the yaw angle of 30 degrees in the negative direction of the X axis, and sensing the negative direction of X axis produces a pitch angle of 20 degrees. Then, based on the perception of the above mentioned angles, the flight command generating the corresponding operation is transmitted to the airborne flight control system 11 through the communication relay device 12. The airborne flight control system 11 controls the aircraft to do the same yaw, roll and pitch as the smart terminal 13 after receiving the flight command

Alternatively, the smart terminal 13 may also yaw and roll, or yaw and pitch, under the control of the operator or the user. Similarly, the smart terminal 13 sends the corresponding operation command to the airborne flight control system 11 through the communication relay device 12 to make the airborne flight control system 11 control the aircraft to do the same action.

Alternatively, the operation of the flight command generated by the smart terminal 13 may be similar to that of the smart terminal 13, rather than exactly the same. If the smart terminal 13 is yawed by 30 degrees, the generated flight command controls the aircraft to yaw 30 degrees n percent or n times, and n is a natural number. The roll angle and pitch angle are similar to yaw angle, which are not described here.

The smart terminal 13 and the communication relay device 12 can transmit information by a short range transmission technique, such as USB (Universal Serial Bus), NFC (Near Field Communication) or bluetooth.

The airborne flight control system 11 and the communication relay device 12 can transmit information through a remote wireless point to point transmission technique.

The motion sensing flight control system based on a smart terminal provided by the embodiment of the invention, according to the perception of the posture of the smart terminal, the smart terminal generates flight command to indicate that the airborne flight control system controls the flight of the aircraft, and send the flight command to the airborne flight control system to control the flight of the aircraft, so that the aircraft can fly in accordance with the posture of the smart terminal automatically adjust the yaw angle, which achieves the motion sensing flight control based on smart terminal Since the smart terminal can control the aircraft through its own posture, and the click and the sliding control on the smart terminal, the technical level of the operator is effectively reduced, so that the flight control of the aircraft becomes easier. The user does not need to be trained, and accurate control on the unmanned aerial vehicle similar to the remote controller can be achieved through motion sensing control. The use of smart phones to achieve this method, it does not need require to special motion sensing equipment. Moreover, the smart terminal communicates with the airborne flight control system on the aircraft through the communication relay equipment, which allows the aircraft to fly indoor and non-GPS signals or weak GPS signals while controlling the aircraft for over the horizon flight.

Illustratively, the above airborne flight control system includes a microprocessor, and a first wireless data transmission module connected to the microprocessor;

The microprocessor is configured to receive the flight command from the communication relay device through the first wireless data transmission module, and to control the flight of the aircraft according to the flight command

Illustratively, the above airborne flight control system further includes a positioning module, a navigation position reference system, and a barometer module;

The positioning module, the navigation position reference system, and the barometer module are respectively connected to the microprocessor;

The microprocessor is further configured to acquire the flight information of the aircraft through the positioning module, the navigation position reference system, and the barometer module. The microprocessor sends the flight information to the smart terminal through the first wireless data transmission module and the communication relay device. In this way, when the smart terminal receives the flight information, the operator or user of the smart terminal can determine the posture of handled smart terminal according to the flight information of the aircraft, or what operation is carried out on the smart terminal Then, the corresponding flight command is generated by the smart terminal, and the current flight of the aircraft is further controlled.

Illustratively, the flight information obtained by the microprocessor includes at least one of a coordinate position of the aircraft, a flying height, a roll angle, a pitch angle, a yaw angle of the aircraft, a flight speed in the front to back direction, and a flight speed in the left and right direction.

Illustratively, the above described communication relay device includes a first relay module, and a second wireless data transmission module connected to the first relay module;

The second wireless data transmission module is configured to wireless communication with the airborne flight control system;

The first relay module is configured to communicate with the smart terminal

Illustratively, the smart terminal includes an attitude sensor, a control module, and a second relay module. The attitude sensor and the second relay module are respectively connected to the control module;

The attitude sensor is configured to acquire an attitude information of the smart terminal;

The control module is configured to generate the flight command according to the attitude information and send the flight command to the second relay module;

The second relay module is configured to send the flight command to the airborne flight control system through the communication relay device.

Illustratively, the smart terminal further includes a steering interface module.

The steering interface module is connected to the control module, which is configured to receive a manipulation command of the user.

The control module is further configured to generate a command for controlling the flying height of the aircraft according to the manipulation command.

The steering interface module can be a touch screen of a smart phone or a tablet computer.

Illustratively, the attitude information includes at least one of the pitch angle, and the roll angle of the smart terminal The flight command generated by the smart terminal further carries at least one of the pitch angle and the roll angle, which is configured to correspondingly control at least one of the pitch angle and the roll angle of the aircraft. Or the flight command generated by the smart terminal further carries a cruising speed for controlling the flight of the aircraft at the cruising speed. The cruising speed is based on at least one of the pitch angle and the roll angle.

### Embodiment 2

In the present embodiment, the smart terminal is a mobile phone, namely, the mobile phone serves as a motion sensing control device of the aircraft to control the flight of the aircraft.

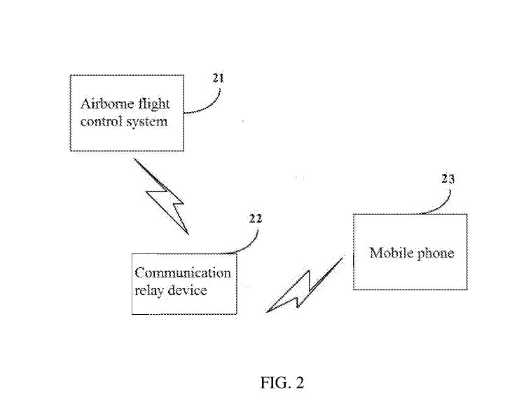

Referring to FIG. 2, the motion sensing flight control system based on a smart terminal according to a second embodiment of the present invention includes an airborne flight control system 21, a communication relay device 22, and a mobile phone 23.

Therein, the airborne flight control system 21 can provide three control methods to control the flight of the aircraft, which is a fixed height flight, a fixed point flight and a pointing flight.

In the fixed height flight mode, the control input received by the airborne flight control system 21 is the target roll angle, a target pitch angle, a target yaw angle, a target height change rate of the aircraft. In the fixed point flight mode, the control input received by the airborne flight control system 21 is the target forward flight speed, the target lateral flight speed, the target yaw angle, and the target height change rate of the aircraft. In the pointing flight mode, the control input received by the airborne flight control system 21 is the target waypoint, and the unmanned aerial vehicle can automatically plan a route and fly to a target waypoint.

The communication between the airborne flight control system 21 and the motion sensing control device (mobile phone 23) uses a communication relay device 22. The airborne flight control system 21 communicates with the communication relay device 22 via a wireless data transmission module. The mobile phone 23 communicates with the communication relay device 22 via bluetooth. The communication relay device 22 realizes forwarding of data between the two, so that the user can manipulate the unmanned aerial vehicle within a radius of 1 km through a motion sensing device such as a mobile phone 23. The communication relay device 22 used in the present embodiment can be an integrated bluetooth communication box.

The mobile phone 23 (or other motion sensing control device) can detect the own pitch, the roll angle and the yaw angle of itself in space in real time. In detail, an application software (APP) can be installed in the mobile phone 23 to collect and use motion sensing information.

In the fixed height flight mode, the APP in the mobile phone 23 sends the pitch angle, the roll angle, and the yaw angle of its own as the target pitch angle, the target roll angle and the target yaw angle of the aircraft to the airborne flight control system.

In the fixed point flight mode, the APP converts the pitch angle, the roll angle, and the yaw angle of the mobile phone 23 to the aircraft's forward flight speed, the left and right direction of flight speed and yaw angle.

In the above two modes, the flying height of the airplane can be adjusted by sliding the slider on the APP interface of the mobile phone 23 to set the target height change rate of the aircraft.

On the APP of the mobile phone 23, it is possible to seamlessly switch between the above described fixed height flight mode, the fixed point flight mode, and the pointing flight mode.

When the airplane or aircraft where the airborne flight control system 21 is flying outdoors, a fixed point flight mode can be used if the environment is open. If the number of trees in the surrounding buildings have more or more need for precise control of aircraft flight or control of aircraft maneuvering can use the motion sensing control of the fixed point flight mode and the fixed height flight mode. When the airplane or aircraft where the airborne flight control system 21 is in flight, the fixed height mode can be used so that the aircraft can be accurately controlled in a GP free environment without the aid of a remote controller.

Compared with the prior art, the multi-rotor unmanned aerial vehicle is controlled through a traditional remote controller, and the operation hand is required to simultaneously control the control of four channels of an accelerator, a pitching, a roll, an yaw or the like of the aircraft, and the operation hand is required to observe the course angle of the aircraft in real time, so that the aircraft can be accurately controlled. The motion sensing flight control system based on a smart terminal provided by the embodiment of the invention, the aircraft can be controlled in a motion sensing mode, and the posture or the flight direction of the unmanned aerial vehicle is directly related to the posture of the aircraft in the space. In detail, the invention provides a motion sensing flight control system based on a smart terminal, the posture angle or the flying speed of the unmanned aerial vehicle in the space and the height change rate are controlled by detecting the spatial posture angle of the motion sensing equipment. The user can adjust the mobile phone (or other motion sensing equipment) by adjusting the mobile phone (or other motion sensing equipment), and the whole control of the aircraft can be completed through the sliding strips with the high spatial attitude and the operation control height. The course of the aircraft is consistent with the orientation of the mobile phone, and the operation is simple, convenient and reliable. In the specific application, the mobile phone is used as the motion sensing control equipment in the flight control system, the user can conveniently use the method, and can be seamlessly switched with other control modes. The method can also be applied to other customized motion sensing equipment.

### Embodiment 3

The present embodiment provides a smart terminal for controlling flight of an aircraft. The smart terminal can be applied to any of the smart terminal based motion sensing flight control systems provided in the above embodiments.

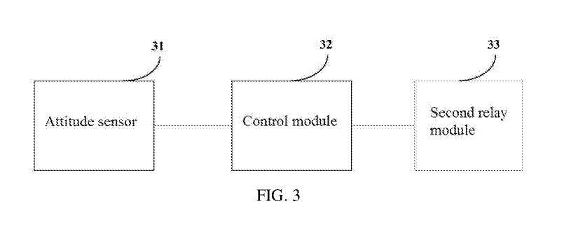

Referring to FIG. 3, a smart terminal for controlling flight of an aircraft provided by the present embodiment includes an attitude sensor 31, a control module 32, and a second relay module 33.

The attitude sensor 31 and the second relay module 33 are connected to the control module 32, respectively.

The attitude sensor 31 is configured to acquire attitude information of the smart terminal, wherein the attitude information includes at least a yaw angle of the smart terminal Such as the smart terminal is rotated by 30 degrees about the upward axis (Z axis) of the right hand system towards the X axis (the front axis of the right hand system) in the negative direction of the operator or the user, the attitude sensor 31 can sense the smart terminal (Z axis) around the right hand system to the orientation of the X axis (the front axis of the right hand system) in the negative direction. In another example, when the smart terminal is rotated by 30 degrees in the negative direction of the Z axis towards the X axis, further rotated about 10 degrees in the positive direction of the X axis towards the Z axis and about 20 degrees in the right hand axis (Y axis) towards the negative direction of the X axis, and then the attitude sensor 31 can sense the posture of the smart terminal and obtain the attitude information, namely, the smart terminal is rotated by 30 degrees in the negative direction of the Z axis towards the X axis, and also rotated around the X axis to the positive direction of the Z axis by 10 degrees, and rotated around the right axis (Y axis) of the right hand to the negative direction of the X axis by 20 degrees and so on.

The control module 32 is configured to generate the flight command based on the attitude information and send the flight command to the second relay module 33, wherein the flight command carries at least the yaw angle for indicating that the aircraft is flying at the yaw angle.

The second relay module 33 is configured to send the flight command to the airborne flight control system of the aircraft through the communication relay device. For example, when the flight command is at yaw 30 degrees, the airborne flight control system controls the aircraft locate at yaw 30 degrees with the commands, and so on.

Illustratively, the smart terminal further comprises a steering interface module.

The steering interface module is connected to the control module, which is configured to receive the manipulation command of the user.

The control module is further configured to generate a command for controlling the flying height of the aircraft according to the manipulation command The steering interface module can be an APP interaction interface such as a sliding bar, a dialog box and so on.

Illustratively, the attitude information acquired by the attitude sensor 31 described above further includes at least one of a pitch angle and a roll angle of the smart terminal The flight instruction generated by the control module 32 also carries at least one of the pitch angle and the roll angle which is used to control at least one of the pitch angle and the roll angle of the aircraft. Alternatively, the flight command generated by the control module 32 also carries a cruising speed for controlling the flight of the aircraft at the cruising speed, wherein the cruising speed is based on at least one of the pitch angle and the roll angle. The control module 32 converts the pitch angle in the attitude information into a forward horizontal flight speed, and converts the roll angle in the attitude information into a left and right horizontal flight speed. When the aircraft is at a fixed point flight, the control module 32 can send the converted flight speed to the airborne flight control system to control the flight of the aircraft.

The smart terminal provided by the present embodiment, acquires its own attitude information through the attitude sensor, generates flight command from the attitude information through the control module, and sends the flight command to the communication relay device through the second relay module so that the airborne flight control system can obtain the smart terminal issued under the flight command sent through the communication relay equipment, and in accordance with the flight command to control the flight of the aircraft, so that the aircraft can fly in accordance with the posture of the smart terminal automatically adjust the yaw angle, which achieves motion sensing flight based on smart terminal of the aircraft. Since the smart terminal can control the aircraft through its own posture, and the click and the sliding control on the smart terminal, the technical level of the operator is effectively reduced, so that the flight control of the aircraft becomes easier. The user does not need to be trained, and accurate control on the unmanned aerial vehicle similar to the remote controller can be achieved through motion sensing control. The use of smart phones to achieve this method, it does not need require to special motion sensing equipment. In addition, the airborne flight control system of the aircraft is communicated with the smart terminal through the communication relay module. The communication relay equipment is communicated with the airborne flight control system of the aircraft. The communication relay module and the communication relay equipment are connected with the smart terminal through the bluetooth signal, the communication relay module and the communication relay equipment is connected to airborne flight control system of the aircraft through the wireless data transmission module, which can not only achieve real time controlling, and allows the aircraft to fly indoor and non-GPS signals or weak GPS signals while controlling the aircraft for over the horizon flight.

### Embodiment 4

The present embodiment provides an airborne flight control system. The airborne flight control system can be applied to the above mentioned motion sensing flight control system smart based on smart terminal.

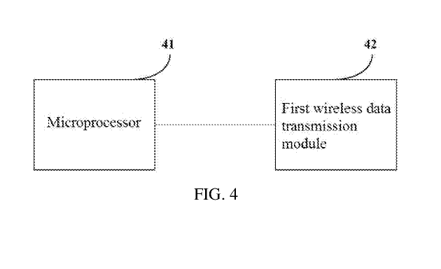

Referring to FIG. 4, an airborne flight control system provided by the present embodiment includes a microprocessor 41, and a first wireless data transmission module 42 connected to the microprocessor 41.

The microprocessor 41 is configured to receive a flight instruction from the communication relay device through the first wireless data transmission module 42 which is sent from the smart terminal and to control the flight of the aircraft according to the flight instruction. The flight command carries at least a yaw angle for indicating that the airborne flight control system controls the aircraft on which the airborne flight control system is located to fly at the yaw angle, and the yaw angle is the yaw angle of the smart terminal.

Illustratively, the above airborne flight control system provided by an embodiment of the present invention further includes a positioning module, a navigation position reference system, and a barometer module.

The positioning module, the navigation position reference system, and the barometer module are respectively connected to the microprocessor.

The microprocessor 41 is further configured to obtain flight information of the aircraft through the positioning module, the navigation position reference system, and the barometer module. The microprocessor 41 sends the flight information to the smart terminal through the first wireless data transmission module 42 and the communication relay device.

Illustratively, the flight information obtained by the microprocessor 41 includes at least the coordinate position of the aircraft, the flying height, the roll angle, the pitch angle, the yaw angle of the aircraft, the flight speed in the front to back direction, and the flight speed in the left and right direction.

The airborne flight control system provided by the present embodiment acquires the flight command issued by the smart terminal according to its own posture from the communication relaying device through the first wireless data transmission module and controls the aircraft to fly according to the flight command by the microprocessor, so that the aircraft can fly in accordance with the posture of the smart terminal automatically adjust the yaw angle, which achieves the motion sensing flight control based on smart terminal. Moreover, the smart terminal can control the aircraft through its own posture, and the click and the sliding control on the smart terminal, the technical level of the operator is effectively reduced, so that the flight control of the aircraft becomes easier. The user does not need to be trained, and accurate control on the unmanned aerial vehicle similar to the remote controller can be achieved through motion sensing control.

### Embodiment 5

The present embodiment provides a communication relay device. The communication relay device can be applied to the above mentioned motion sensing flight control system based on a smart terminal

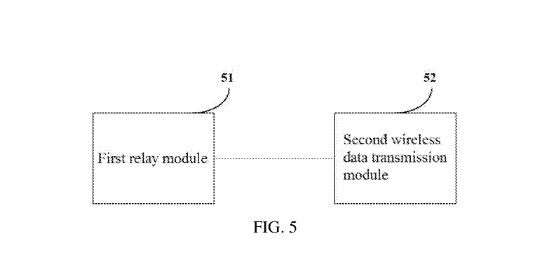

Referring to FIG. 5, a communication relay device provided in the present embodiment includes a first relay module 51 and a second wireless data transmission module 52 connected to the first relay module 51.

The first relay module 51 can be an interface module such as bluetooth, NFC, and USB for communicating with the smart terminal to receive a flight command sent by the smart terminal. Wherein, the flight command carries at least a yaw angle for indicating that the airborne flight control system controls the aircraft on which the airborne flight control system is located to fly at the yaw angle, the yaw angle being the yaw angle of the smart terminal

The second wireless data transmission module 52 is configured to wireless communication with the airborne flight control system for sending the flight instruction to the airborne flight control system.

The communication relay device provided by the present embodiment obtains a flight command issued by the smart terminal according to its own posture through the first relay module and sends the flight command to the airborne flight control system through the second wireless data transmission module. So that the airborne flight control system can be located in the indoor and non-GPS signals or places with weak GPS signals, and the yaw angle is automatically modulated according to the attitude of the smart terminal, which realizes the motion sensing flight control based on smart terminal Moreover, the smart terminal can control the aircraft through its own posture, and the click and the sliding control on the smart terminal, the technical level of the operator is effectively reduced, so that the flight control of the aircraft becomes easier. The user does not need to be trained, and accurate control on the unmanned aerial vehicle similar to the remote controller can be achieved through motion sensing control.

### Embodiment 6

The present embodiment provides another motion sensing flight control system based on a smart terminal

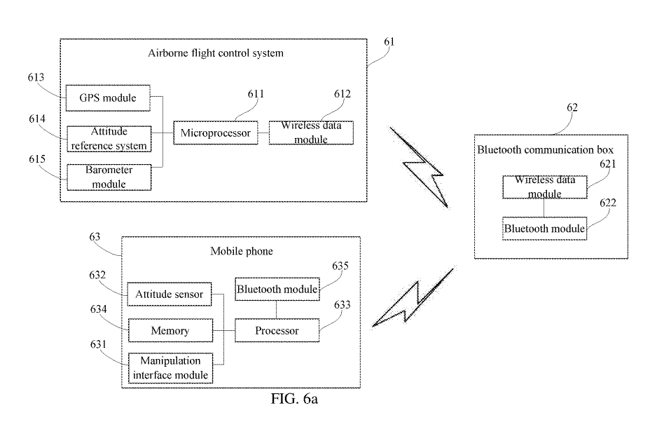

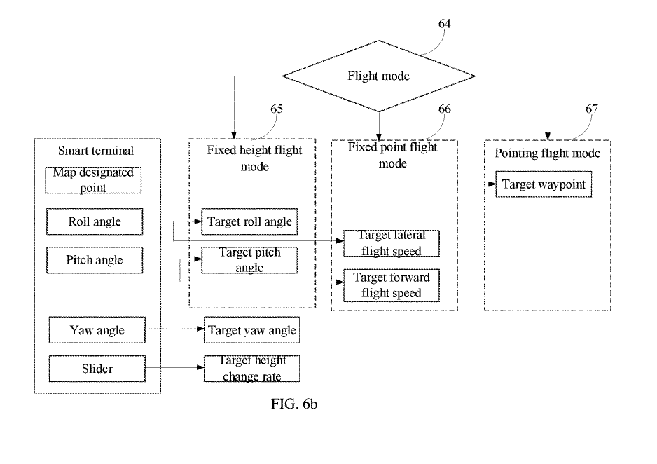

Referring to FIG. 6a, a motion sensing flight control system based on a smart terminal provided by the present embodiment includes an airborne flight control system 61, a bluetooth communication box 62, and a mobile phone 63.

The airborne flight control system 61 includes a microprocessor 611, a wireless data transmission module 612, a positioning system GPS (Global Positioning System) module 613, an Altitude Heading Reference System (AHRS) 614, a barometer module 615, a wireless data module 612, a GPS module 613, an attitude reference system 614, and a barometer module 615. The wireless data module 612, the GPS module 613, the attitude reference system 614, and the barometer module 615 are connected to the microprocessor 611 respectively. The microprocessor 611 acquires the flight information of an aircraft where the airborne flight control system is located through the GPS module 613, the posture reference system 614 and the barometer module 615.

The bluetooth communication box 62 belongs to the above-described communication relay device, and includes a wireless data transmission module 621, and a bluetooth module 622. The wireless data transmission module 621 is connected to the bluetooth module 622.

The mobile phone 63 includes a manipulation interface module 631, an attitude sensor 632, a processor 633, a memory 634, and a bluetooth module 635. The manipulation interface module 631, the attitude sensor 632, the memory 634, and the bluetooth module 635 are connected to a processor 633.

The bluetooth module 634 communicates data with the bluetooth module 622 in the bluetooth communication box 62 by bluetooth technology. The wireless data module 621 in the bluetooth communication box 62 communicates data with the wireless data transmission module 612 in the airborne flight control system 61 by the remote radio transmission technology. Such as, the data to be transmitted is modulated to a 2.4 GHz carrier and the date to be received is received to 2.4 GHz carrier signal.

The manipulation interface module 631 is configured to receive manipulation commands generated by the user clicking and/or sliding control on the touch screen.

The attitude sensor 632 includes a motion sensor such as a three axis gyroscope, a three axis accelerometer, and a three axis electronic compass, which is configured to obtain attitude information of the mobile phone 63, such at least one of the pitch angle, the roll angle and the yaw of the mobile phone. The APP code is stored in the memory 634. The processor 633 invokes and runs the APP code from the memory 634. The mobile phone APP may obtain the roll angle, the pitch angle, the yaw angle of the mobile phone 63 through the attitude sensor 632, and obtain the slider position for controlling the flying height of the aircraft by manipulating the interface module 631, and the user is designated on the map via a target point of the touch screen.

The APP generates a flight command based on the manipulation command or the attitude information of the mobile phone 63 and sends the flight command to the bluetooth module 634.

The bluetooth module 634 is configured to send the flight command to the bluetooth module 622 in the bluetooth communication box 62, and then the bluetooth communication box 62 sends the flight command to the wireless data transmission module 612 via the wireless data transmission module 621.

The microprocessor 611 is configured to receive the flight command received via the wireless data transmission module 612, and the flight state of the aircraft is controlled according to the flight command

The microprocessor 611 is configured for the positioning module to send the flight information of the aircraft to the wireless data transmission module 621 through the wireless data transmission module 612, and then the bluetooth communication box 62 sends the flight information to the bluetooth module 634 of the mobile phone 63 via the bluetooth module 622. The App running in the mobile phone acquires the flight information from the bluetooth module 634.

The mobile phone 63 controls the motion sensing manipulation of the aircraft as shown in FIG. 6b, and includes the operation 64 to operation 67.

In operation 64, the mobile phone judges the flight mode of the current aircraft according to the flight information sent by the airborne flight control system, and generates the corresponding flight command according to the judgment result.

In operation 65, when the aircraft flies in a fixed height flight mode, the APP sends the pitch angle and the yaw angle of the mobile phone as a target pitch angle and a target yaw angle to the airborne flight control system. The unmanned aerial vehicle is controlled by the airborne flight control system to achieve real time following the mobile phone spatial attitude. At this point, the user can adjust the spatial attitude by directly manipulating the unmanned aerial vehicle directly by rotating and tilting the phone. For safety reasons, the maximum target inclination of the unmanned aerial vehicle directly can be limited. The user can make the unmanned aerial vehicle directly at the horizontal attitude by horizontally arranging the mobile phone.

In operation 66, when the aircraft flies in a fixed point flight mode flight, the APP makes the pitching angle and the roll angle of the mobile phone to be multiplied by a ratio coefficient and respectively convert the unmanned aerial vehicle target forward flight speed and target horizontal flight speed, and send which to the airborne flight control system to control the aircraft. So that, the target flight direction of the unmanned aerial vehicle is the direction of the inclination of the mobile phone. The target flight speed of the unmanned aerial vehicle is directly related to the inclination angle of the mobile phone. Then, the user can hover the aircraft at a fixed point through a horizontally arranged mobile phone.

In operation 67, when the aircraft flies in a pointing flight mode, the inclination of the mobile phone does not affect the flight of the unmanned aerial vehicle. The APP sends the user's location on the map to the airborne flight control system, and the unmanned aerial vehicle automatically moves to the designated point.

In all flight modes, the unmanned aerial vehicle can keep a fixed flight height, and when the user slides the slider of the height control, the APP sends a corresponding target vertical speed command to the airborne flight control system according to the slider position. Moreover, in all modes, the APP can send the yaw angle of the mobile phone as a target yaw angle to the airborne flight control system. The unmanned aerial vehicle can be controlled to follow the yaw angle of the mobile phone in real time through a feedback control of the flight control system.

The fixed flight mode can be used without GPS conditions, and is suitable for the complex environments such as indoor buildings, building rooms and jungle forests. All flight modes can be used in general outdoor conditions and can be switched seamlessly at any time.

When the motion sensing control method is used, the direction of the head of the unmanned aerial vehicle is aligned with the forward direction of the mobile phone (or other motion sensing device), and the inclination angle direction of the unmanned aerial vehicle (in fixed height flight mode) or the speed direction is the actual movement of the object is consistent with the inclination direction of the mobile phone. Therefore, when the unmanned aerial vehicle carries the camera for aerial photography, the user can specify the direction of the aircraft directly by rotating the mobile phone (or other motion sensing device) without having to observe the actual yaw of the aircraft by tilting the phone in the specified direction. The unmanned aerial vehicle can be controlled to fly or accelerate in the direction only by inclining the mobile phone towards the designated direction. In particular, when it is need to back navigation, the user only needs to face the direction in which the aircraft is located and tilt the mobile phone towards the direction of the user.

It should be noted that the above “first” and “second” have no special meaning, just to distinguish between different modules.

It is noted that the above is only the preferred embodiment of the present invention and the technical principle applied. It will be understood by those skilled in the art that the present invention is not limited to the specific embodiments described herein, and various obvious changes, readjustments and substitutions can be made to persons skilled in the art without departing from the protection scope of the invention. Therefore, although the present invention has been described in more detail through the above embodiments, the present invention is not limited to the above embodiments, more other equivalent embodiments can be included without departing from the concept of the present invention, the scope of the invention is determined by the appended claims.

1. A motion sensing flight control system based on a smart terminal, comprising an airborne flight control system, a communication relay device, and a smart terminal;
wherein the smart terminal is configured to acquire attitude information of the smart terminal, generate a flight command according to the attitude information, and send the flight command to the airborne flight control system through the communication relay device;
wherein the attitude information comprises at least a yaw angle of the smart terminal, and the flight command at least carries the yaw angle for indicating that the airborne flight control system controls an aircraft flying at the yaw angle; and
wherein the airborne flight control system is configured to control the flight of the aircraft in accordance with the flight command.

2. The system of claim 1, wherein the airborne flight control system comprises a microprocessor, and a first wireless data transmission module connected to the microprocessor; and
wherein the microprocessor is configured to receive the flight command from the communication relay device through the first wireless data transmission module, and control the flight of the aircraft according to the flight command.

3. The system of claim 2, wherein airborne flight control system further comprises a positioning module, a navigation position reference system, and a barometer module;
wherein the positioning module, the navigation position reference system, and the barometer module are respectively connected to the microprocessor; and
wherein the microprocessor is further configured to acquire the flight information of the aircraft through the positioning module, the navigation position reference system, and the barometer module, and send the flight information to the smart terminal through the first wireless data transmission module and the communication relay device.

4. The system of claim 3, wherein the flight information obtained by the microprocessor comprises at least one of a coordinate position of the aircraft, a flying height, a roll angle, a pitch angle, a yaw angle of the aircraft, a flight speed in the front to back direction, and a flight speed in the left and right direction.

5. The system of claim 1, wherein the communication relay device comprises a first relay module, and a second wireless data transmission module connected to the first relay module;
wherein the second wireless data transmission module is configured to wireless communication with the airborne flight control system; and
wherein the first relay module is configured to communicate with the smart terminal.

6. The system of claim 1, wherein the smart terminal comprises an attitude sensor, a control module, and a second relay module, the attitude sensor and the second relay module are respectively connected to the control module;
wherein the attitude sensor is configured to obtain an attitude information of the smart terminal;
wherein the control module is configured to generate the flight command according to the attitude information and send the flight command to the second relay module; and
wherein the second relay module is configured to send the flight command to the airborne flight control system through the communication relay device.

7. The system of claim 6, wherein the smart terminal further comprises a steering interface module connected to the control module, which is configured to receive a manipulation command by a user, and the control module is further configured to generate a command for controlling the flying height of the aircraft according to the manipulation command.

8. The system of claim 6, wherein the attitude information comprises at least one of the pitch angle, and the roll angle of the smart terminal, the flight command generated by the smart terminal further carries at least one of the pitch angle and the roll angle to correspondingly control at least one of the pitch angle and the roll angle of the aircraft, or, the flight command generated by the smart terminal further carries a cruising speed for controlling the flight of the aircraft at the cruising speed; wherein the cruising speed is based on at least one of the pitch angle and the roll angle.

9. A smart terminal for controlling the flight of an aircraft, comprising: an attitude sensor, a control module, and a second relay module, the attitude sensor and the second relay module are respectively connected to the control module;
wherein the attitude sensor is configured to obtain an attitude information of the smart terminal, the attitude information at least comprises a yaw angle of the aircraft;
wherein the control module is configured to generate a flight command according to the attitude information and send the flight command to the second relay module, the flight command at least carries the yaw angle for indicating the aircraft flying at the yaw angle; and
wherein the second relay module is configured to send the flight command to the aircraft of an airborne flight control system through the communication relay device.

10. The terminal of claim 9, wherein further comprises a steering interface module connected to the control module, which is configured to receive a manipulation command by a user, and the control module is further configured to generate a command for controlling the flying height of the aircraft according to the manipulation command.

11. The terminal of claim 9, wherein the attitude information comprises at least one of the pitch angle, and the roll angle of the smart terminal, the flight command generated by the control module further carries at least one of the pitch angle and the roll angle to correspondingly control at least one of the pitch angle and the roll angle of the aircraft, or, the flight command generated by the control module further carries a cruising speed for controlling the flight of the aircraft at the cruising speed; wherein the cruising speed is based on at least one of the pitch angle and the roll angle.

12. An the airborne flight control system, comprising a microprocessor, and a first wireless data transmission module connected to the microprocessor;
wherein the microprocessor is configured to receive a flight command of a smart terminal from a communication relay device through the first wireless data transmission module, and control the flight of an aircraft according to the flight command; wherein the flight command at least carries a yaw angle for indicating that the airborne flight control system controls the aircraft flying at the yaw angle, the yaw angle is a yaw angle of the smart terminal.

13. The system of claim 12, wherein further comprises a positioning module, a navigation position reference system, and a barometer module;
wherein the positioning module, the navigation position reference system, and the barometer module are respectively connected to the microprocessor; and
wherein the microprocessor is further configured to acquire the flight information of the aircraft through the positioning module, the navigation position reference system, and the barometer module, and send the flight information to the smart terminal through the first wireless data transmission module and the communication relay device.

14. The system of claim 13, wherein the flight information obtained by the microprocessor comprises at least one of a coordinate position of the aircraft, a flying height, a roll angle, a pitch angle, a yaw angle of the aircraft, a flight speed in the front to back direction, and a flight speed in the left and right direction.

15. (canceled)
